(19) United States
(12) Patent Application Publication
(10) Pub. No.: US 2023/0140199 A1
(43) Pub. Date: May 4, 2023

(54) METHODS FOR DETECTING PROBLEMS AND RANKING ATTRACTIVENESS OF REAL-ESTATE PROPERTY ASSETS FROM ONLINE ASSET REVIEWS AND SYSTEMS THEREOF

(71) Applicant: SKYLINE AI LIMITED, Tel-Aviv (IL)

(72) Inventors: Adam HABER, Habonim (IL); Zeev WAKS, Ness Ziona (IL)

(21) Appl. No.: 17/585,207

(22) Filed: Jan. 26, 2022

Related U.S. Application Data
(60) Provisional application No. 63/272,981, filed on Oct. 28, 2021.

(51) Int. Cl. G06Q 50/16; G06K 9/62; G06N 20/00

(52) U.S. Cl. CPC G06Q 50/16; G06K 9/6267; G06K 9/626; G06N 20/00

(57) ABSTRACT

This technology automates assessment of real-estate property assets by aggregating a heterogeneous dataset of stored online asset reviews for one or more property assets based on one or more search criteria. Next, labeling of a subset of the aggregated heterogeneous dataset in one or more pre-defined property asset problem categories with one or more labeler computing devices is managed. One or more machine learning models are trained in text classification based on the labelled subset and another unlabeled subset of the heterogeneous dataset of stored online asset reviews. The trained one or more machine learning models in text classification are executed on the heterogeneous dataset of stored online asset reviews to calculate a category assessment score in each of the pre-defined property asset problem categories. A property asset assessment score for each of the one or more property assets is calculated based on the calculated category assessment score in each of the pre-defined property asset problem categories.

This application claims the benefit of U.S. Provisional Patent Application No. 63/272,981, filed Oct. 28, 2021, which is hereby incorporated by reference in its entirety.

### FIELD

This technology relates to methods for detecting problems and ranking attractiveness of real-estate property assets from online asset reviews and systems thereof.

### BACKGROUND

Online reviews of multifamily residential properties present a unique source of information for commercial real estate investing and research. Real estate professionals frequently read online reviews to try and uncover property-related issues that are otherwise difficult to detect. Unfortunately, this approach is biased, time-consuming, and often not effective.

The use of artificial intelligence in commercial real estate investing is growing given the availability of new data modalities. Motivated by the potential for new insights and improving investment decisions in the large real estate market, recent efforts have used cellular network data, satellite images C:\Users\heeksmf\AppData\Local\Microsoft\Windows\INetCache\Content.Outlook\AXP2P883\h-bookmark47, building permits, interior and exterior photos for luxury estimation and automated appraisal, and construction of new retail stores for predicting future rent growth, among others. However, one of the mostly untapped, yet highly informative, data sources, are online reviews of various properties.

Online reviews of properties in which tenants reside present a unique source of information in the multifamily domain due to their distinctive, tenant-perspective view. In recent years, the popularity of such reviews has grown so that there are now millions of newly generated reviews annually, with some properties garnering hundreds and even thousands of reviews over time. Nonetheless, these online reviews are rarely constrained to a specific format and can drastically vary in length, grammar, and linguistic style. As a result, any manual review is only able to manage a small subset of available online reviews that often is an unrepresentative sample of the massive heterogeneous dataset that is available. Additionally, any such manual review of even the same subset of online reviews would often vary from reviewer to reviewer because of inherent subjective biases.

Text classification refers to the process of categorizing textual data into a set of defined classes. Classical approaches to text classification rely on feature extraction techniques, such as n-grams, Bag-of-Words, and TF-IDF, a potential dimensionality reduction step, followed by learning a classification model such as Logistic Regression, Naive Bayes, Support Vector Machines, Latent Dirichlet Allocation, and Nearest-Neighbors algorithms. Unfortunately, a commonality across many previously existing review classification efforts is that the review classes are generally broadly defined and are unable to effectively and accurately handle the heterogeneous nature of the corpus of data being processed. As a result, these prior approaches have only been able to provide coarse-grained classification at best which are not effective or accurate for any further analytics.

### SUMMARY

A method for automating assessment of real-estate properties that includes aggregating, by a computing device, a heterogeneous dataset of stored online asset reviews for one or more property assets based on one or more search criteria. Managing, by the computing device, labeling of a subset of the aggregated heterogeneous dataset in one or more pre-defined property asset problem categories with one or more labeler computing devices. One or more machine learning models are trained, by the computing device in text classification based on the labelled subset and another unlabeled subset of the heterogeneous dataset of stored online asset reviews. The trained one or more machine learning models in text classification are executed, by the computing device, on the heterogeneous dataset of stored online asset reviews to calculate a category assessment score in each of the pre-defined property asset problem categories. A property asset assessment score for each of the one or more property assets is calculated, by the computing device, based on the calculated category assessment score in each of the pre-defined property asset problem categories.

A non-transitory machine readable medium having stored thereon instructions comprising executable code that, when executed by one or more processors, causes the processors to aggregate a heterogeneous dataset of stored online asset reviews for one or more property assets based on one or more search criteria. Managing labeling of a subset of the aggregated heterogeneous dataset in one or more pre-defined property asset problem categories with one or more labeler computing devices. One or more machine learning models are trained in text classification based on the labelled subset and another unlabeled subset of the heterogeneous dataset of stored online asset reviews. The trained one or more machine learning models in text classification are executed on the heterogeneous dataset of stored online asset reviews to calculate a category assessment score in each of the pre-defined property asset problem categories. A property asset assessment score for each of the one or more property assets is calculated based on the calculated category assessment score in each of the pre-defined property asset problem categories.

A computing device comprising memory comprising programmed instructions stored thereon and one or more processors configured to execute the stored programmed instructions to aggregate a heterogeneous dataset of stored online asset reviews for one or more property assets based on one or more search criteria. Managing labeling of a subset of the aggregated heterogeneous dataset in one or more pre-defined property asset problem categories with one or more labeler computing devices. One or more machine learning models are trained in text classification based on the labelled subset and another unlabeled subset of the heterogeneous dataset of stored online asset reviews. The trained one or more machine learning models in text classification are executed on the heterogeneous dataset of stored online asset reviews to calculate a category assessment score in each of the pre-defined property asset problem categories. A property asset assessment score for each of the one or more property assets is calculated based on the calculated category assessment score in each of the pre-defined property asset problem categories.

This technology provides a number of advantages including providing methods, non-transitory computer readable media, and computing apparatuses that effectively, accurately and consistently detect problems and rank attractiveness of real-estate property assets from an aggregation of heterogeneous online asset reviews. Additionally, examples of the claimed technology systematically minimize and/or eliminate errors with analyzing this vast heterogeneous dataset of online reviews to provide an efficient, accurate, and consistent scored output in the selected pre-defined property asset problem categories. Further, examples of the claimed technology are able to further adjust the property asset assessment score to adjust for other factors relating to the significance of the each of the determined scores in each of the pre-defined property asset problem categories.

### BRIEF DESCRIPTION OF THE DRAWINGS

FIG. 1 is a diagram of an exemplary environment with an example of an asset analysis computing device.

FIG. 2 is a block diagram of the example of the asset analysis computing device shown in FIG. 1.

FIG. 3 is a functional block diagram of an example of a method for detecting problems and ranking attractiveness of real-estate property assets from online asset reviews.

FIG. 4A is a graph of an example a number of reviews per property for the exemplary online reviews dataset.

FIG. 4B is a graph of an example a number of words per review for the exemplary online reviews dataset.

FIG. 4C is a graph of an example a number of reviews per year for the exemplary online reviews dataset.

FIG. 4D is a map diagram of a numbers of reviews per capita for the exemplary online reviews dataset.

FIG. 5 is a table of exemplary machine learning performance metrics relating to the quality of detection of crime, noise, pests and parking issues.

### DETAILED DESCRIPTION

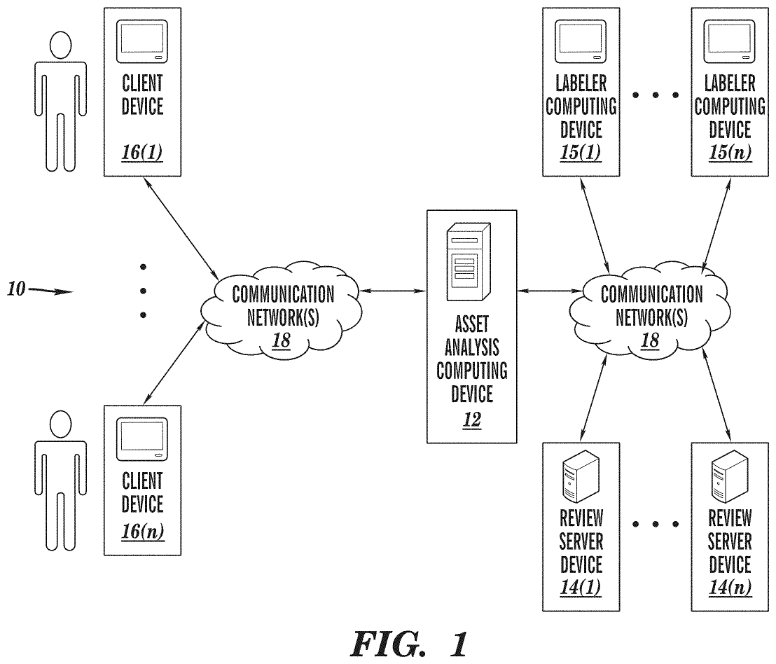

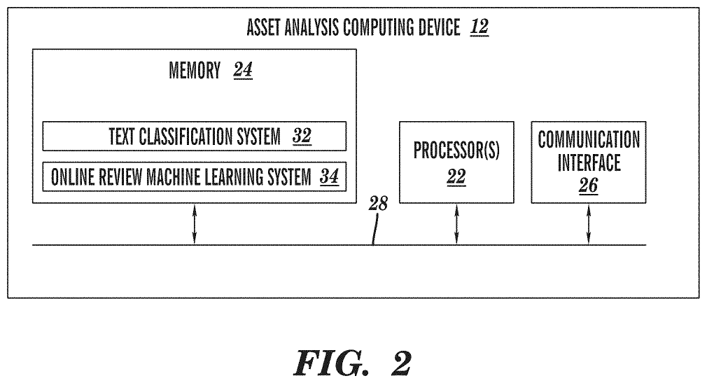

An exemplary environment 10 with an example of an asset analysis computing device 12 is illustrated in FIGS. 1-2. In this illustrative example, the exemplary environment 10 includes the asset analysis computing device 12, a plurality of review server devices 14(1)-14(n), a plurality of labeler computing devices 15(1)-15(n), and a plurality of client devices 16(1)-16(n) coupled together by communication networks 18, although the exemplary environment could include other types and/or numbers of other systems, devices, components, and/or other elements in other configurations. This technology provides a number of advantages including providing methods, non-transitory computer readable media, and computing apparatuses that effectively, accurately and consistently detect problems and rank attractiveness of real-estate property assets from an aggregation of heterogeneous online asset reviews.

Referring more specifically to FIGS. 1-2, the asset analysis computing device 12 in this example includes processor(s) 22, a memory 24, and/or a communication interface 26, which are coupled together by a bus 28 or other communication link, although the asset analysis computing device 12 can include other types and/or numbers of elements in other configurations. The processor(s) 22 of the asset analysis computing device 12 may execute programmed instructions stored in the memory 24 for the any number of the functions described and illustrated herein. The processor(s) 22 of the asset analysis computing device 12 may include one or more CPUs or general purpose processors with one or more processing cores, for example, although other types of processor(s) can also be used.

The memory 24 of the asset analysis computing device 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 22, can be used for the memory 24.

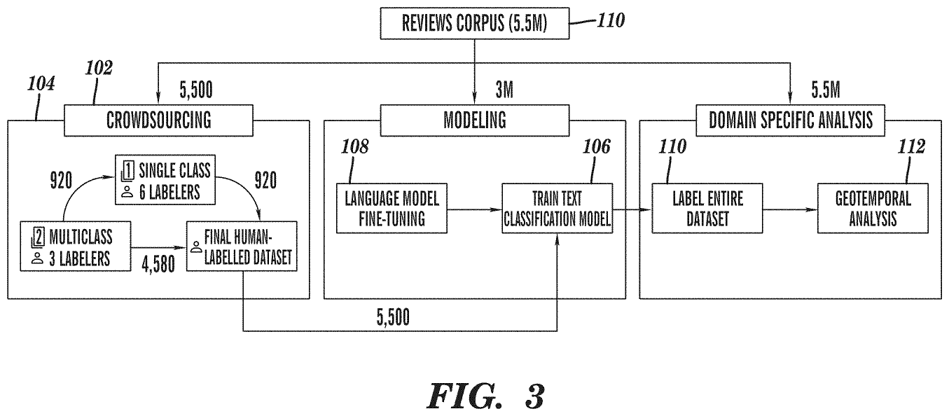

Accordingly, the memory 24 of the asset analysis computing device 12 can store application(s) that can include executable instructions that, when executed by the processor(s) 22, cause the asset analysis computing device 12 to perform actions, such as described and illustrated below with reference to FIGS. 3-5. The application(s) can be implemented as modules or components of other application(s). Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the asset analysis computing device 12 itself, may be located in virtual server(s) running in a cloud-based computing environment rather than being tied to one or more specific physical network computing devices. Also, the application(s) may be running in one or more virtual machines (VMs) executing on the asset analysis computing device 12. Additionally, in one or more embodiments of this technology, virtual machine(s) running on the asset analysis computing device 12 may be managed or supervised by a hypervisor.

In this particular example, the memory 24 of the asset analysis computing device 12 includes a text classification system 32 and an online review machine learning system 34, although the memory 24 can include other policies, modules, databases, or applications, for example. In this example the text classification system 32 is an automated text classification with an optional manual adjustment, although other types of classification systems which are fully or partially automated may be used. The online review machine learning system 34 in this example is configured with programmed instructions, modules, and/or other data for training with respect to a labelled heterogeneous collection of online reviews and for generating an attractiveness score based on an aggregation of scores in one or more pre-defined property asset problem categories which in this example may be weighted, although other types and/or numbers of machine learning systems may be used.

The communication interface 26 of the asset analysis computing device 12 operatively couples and communicates between the asset analysis computing device 12, the review server devices 14(1)-14(n), the labeler computing devices 15(1)-15(n), and/or the client devices 16(1)-16(n), which are all coupled together by the communication networks 18, although other types and/or numbers of communication networks or systems with other types and/or numbers of connections and/or configurations to other devices and/or elements can also be used.

By way of example only, the communication networks 18 can include local area network(s) (LAN(s)) or wide area network(s) (WAN(s)), and can use TCP/IP over Ethernet and industry-standard protocols, although other types and/or numbers of protocols and/or communication networks can be used. The communication networks 18 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The asset analysis computing device 12 can be a standalone device or integrated with one or more other devices or apparatuses, such as one or more of the review server devices 14(1)-14(n), for example. In one particular example, the asset analysis computing device 12 can include or be hosted by one of the review server devices 14(1)-14(n), although other configurations or arrangements may be used.

Each of the review server devices 14(1)-14(n) in this example includes processor(s), a memory, and a communication interface, which are coupled together by a bus or other communication link, although other numbers and/or types of server and/or network devices could be used. The review server devices 14(1)-14(n) in this example host online reviews on property assets and/or other content associated with commentary about property assets in a variety of different formats, by way of example, although the review server devices 14(1)-14(n) may host other types of data and/or other content.

Although the review server devices 14(1)-14(n) are illustrated as single devices, one or more actions of the review server devices 14(1)-14(n) may be distributed across one or more distinct network computing devices that together comprise one or more of the review server devices 14(1)-14(n) and may have no affiliation with each other. Moreover, the review server devices 14(1)-14(n) are not limited to a particular configuration or to one particular entity and may be managed by multiple different entities. Thus, the review server devices 14(1)-14(n) may contain a plurality of network devices that operate using a master/slave approach, whereby one of the network devices of the review server devices 14(1)-14(n) operate to manage and/or otherwise coordinate operations of the other network devices.

The review server devices 14(1)-14(n) or any subset may operate as a plurality of network devices within a cluster architecture, a peer-to peer architecture, virtual machines, or within a cloud architecture, for example. Thus, the technology disclosed herein is not to be construed as being limited to a single environment and other configurations and architectures are also envisaged.

The labeler computing devices 15(1)-15(n) in this example include any type of computing device, such as mobile computing devices, desktop computing devices, laptop computing devices, tablet computing devices, virtual machines (including cloud-based computers), or the like. Each of the labeler computing devices 15(1)-15(n) in this example includes a processor, a memory, and a communication interface, which are coupled together by a bus or other communication link, although other numbers and/or types of network devices could be used. The labeler computing devices 15(1)-15(n) may run interface applications, such as standard Web browsers or standalone client applications, which may provide an interface to for example make requests for, provide content, and receive content stored on, one or more of the server devices via the communication network(s), such as preparing and submitting labels in pre-defined property asset problem categories for online reviews for property assets which can be transmitted to the asset analysis computing device 12 by way of example only. The labeler computing devices 15(1)-15(n) may further include a display device, such as a display screen or touchscreen, and/or an input device, such as a keyboard for example.

The client devices 16(1)-16(n) in this example include any type of computing device, such as mobile computing devices, desktop computing devices, laptop computing devices, tablet computing devices, virtual machines (including cloud-based computers), or the like. Each of the client devices 16(1)-16(n) in this example includes a processor, a memory, and a communication interface, which are coupled together by a bus or other communication link, although other numbers and/or types of network devices could be used. The client devices 16(1)-16(n) may run interface applications, such as standard Web browsers or standalone client applications, which may provide an interface to for example make requests for, provide content, and receive content stored on, one or more of the server devices via the communication network(s), such as preparing and submitting online reviews for property assets or obtaining an attractiveness or other calculated score or output related to one of the property assets by way of example only. The client devices 16(1)-16(n) may further include a display device, such as a display screen or touchscreen, and/or an input device, such as a keyboard for example.

Although the exemplary network environment 10 with the asset analysis computing device 12, review server devices 14(1)-14(n), labeler computing devices 15(1)-15(n), client devices 16(1)-16(n), and communication networks 18 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 10, such as the asset analysis computing device 12, review server devices 14(1)-14(n), labeler computing devices 15(1)-15(n), or client devices 16(1)-16(n), for example, may be configured to operate as virtual instances on the same physical machine. In other words, one or more of the asset analysis computing device 12, review server devices 14(1)-14(n), labeler computing devices 15(1)-15(n), or client devices 16(1)-16(n) may operate on the same physical device rather than as separate devices communicating through communication network(s). Additionally, there may be more or fewer asset analysis computing devices, server devices, or client devices as well as other systems, devices, and/or other elements than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only wireless networks, cellular networks, PDNs, the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processor(s) to carry out steps necessary to implement the methods of the examples of this technology that are described and illustrated.

An example of a method for detecting problems and ranking real-estate property attractiveness from online asset reviews will now be illustrated and described with reference to FIGS. 1-5.

In step 100, the asset analysis computing device 12 identifies and aggregates a heterogeneous dataset of online reviews for one or more selected property assets from one or more of the review server devices 14(1)-14(n) based on one or more search criteria, such as geographic location, property type, property name, and period of time, although the stored reviews can be obtained from other sources in other manners, with other types and/or numbers of other search criteria, and/or for other types of assets. In this particular example, the asset analysis computing device 12 aggregated approximately 5,468,037 online reviews gathered from five different sources, such as five or more of the review server devices 14(1)-14(n) by way of example, covering approximately 96,134 different US multifamily properties assets and spanning twenty-one years from 2000-2020, although other types and/or amounts of stored content for the same or other regions and/or over other set time periods may be used. The total number of words in this particular heterogeneous dataset was approximately 536,702,874, which illustrates the size of this dataset which would make any type of manual review unfeasible. The contribution of these five sources to the total number of reviews varied from 2.3% to 52% of the dataset, with the largest two sources accounting for 91% of the reviews illustrating potential skews which may be in the dataset. As a result, with examples of this technology the asset analysis computing device 12 may apply, set or otherwise determined weights and/or other adjustments to the data based on past reviews and/or any applied analytics to compensate for errors or biases, such as the identified higher concentration of reviews from just two sources which might skew the results or to adjust for other skewing factors in other examples. Additionally, the asset analysis computing device 12 advantageously is able to utilize a heterogeneous dataset of online reviews which is not constrained to any specific format and which online reviews can vary in length, grammar, and linguistic style. Further, in this example the data in the online reviews identified and parsed by the asset analysis computing device 12 for use comprises a review body text and metadata containing the date and the specific property asset associated with the review, although the data parsed from the online reviews could comprise other types and/or amounts of other data.

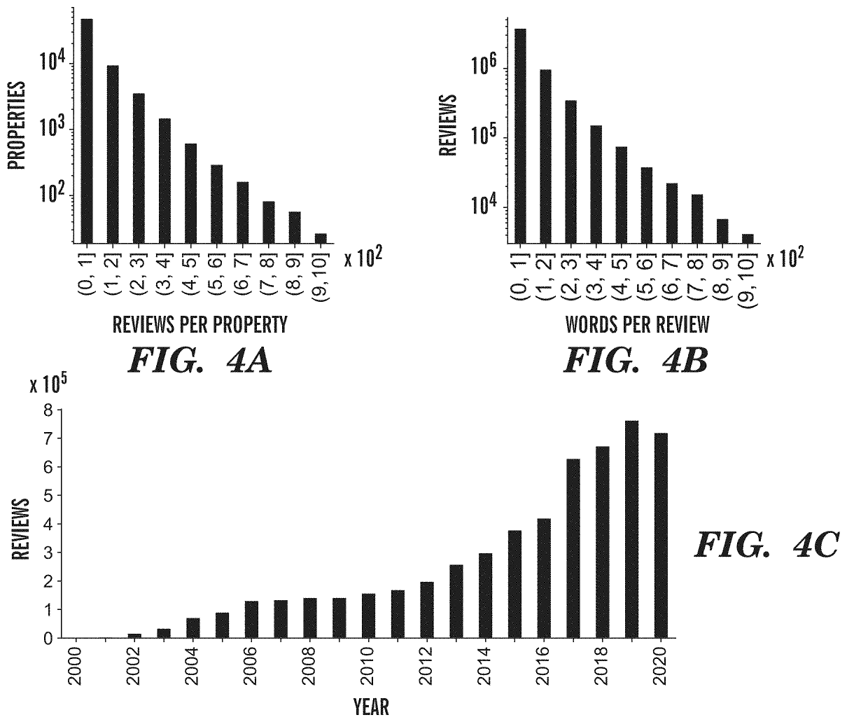

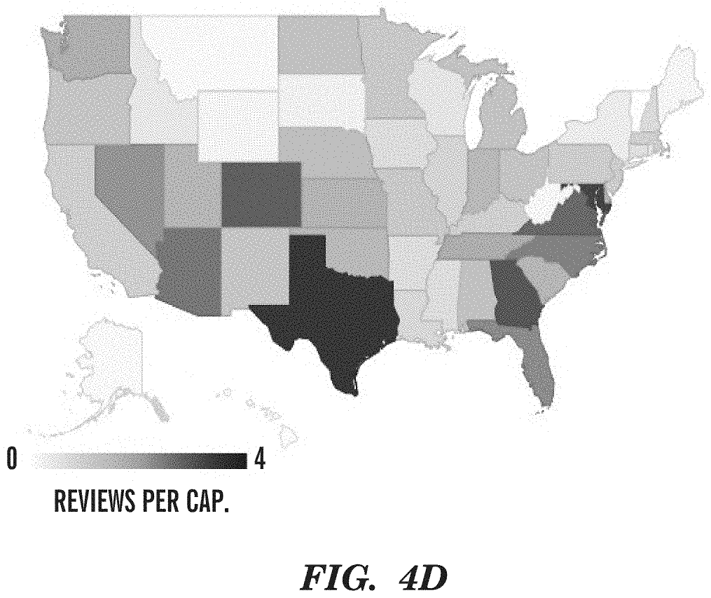

As illustrated in FIGS. 4A and 4B, in this example the distribution of reviews per property asset was skewed as was the distribution of words per review which the asset analysis computing device 12 is able to account and adjust for as illustrated and described by way of examples herein. Additionally, as illustrated in FIG. 4C, in this example the majority of the online reviews (66%) were from recent years (2015-2020), consistent with the increasing popularity of online media and the digitization of commercial real estate. Further as illustrated in FIG. 4D, in this example geographically the online reviews showed nation-wide coverage, with Texas having the largest number of reviews, both in absolute and relative (per-capita) terms which the asset analysis computing device 12 again may account and adjust for as illustrated and described by way of examples herein.

In this example, while the majority of the online reviews comprise data that was positive, such as an online review which stated—“The [property name] staff are great and the residents are nice. It is a quiet and safe place to live”, some of the online reviews comprise data that expressed anger and frustration with the property asset, its surroundings, or its management. For example, another online review stated—“This place Is horrible I would not allow my dogs to live their (sic), drugs being sold and apartments getting robbed stay away from these people”. Accordingly, as illustrated with this small sample, the online reviews vary in variety of factors, such as sentiment, length, grammar, linguistic style, and other aspects, which are addressed by the asset analysis computing device 12 to provide an accurate, effective, and consistent automated analysis as illustrated and described by way of examples herein.

In step 102, the asset analysis computing device 12 randomly samples the heterogeneous dataset of online reviews for one or more property assets, although other manners for obtaining a subset of the aggregated heterogeneous dataset of online reviews could be used, such as a controlled sampling of the heterogeneous dataset based on one or more factors to adjust for any skew in the data by way of example only. In this particular example, the asset analysis computing device 12 randomly sampled 0.1% of the aggregated heterogeneous database of about 5.5 million online review comprising a subset of about 5,500 online reviews, although subsets of other sizes and/or obtained in other manners may be used.

In step 104, the asset analysis computing device 12 manages labeling of a subset of this aggregated heterogeneous dataset in one or more pre-defined property asset problem categories based on executed instructions which provide the subset of this aggregated heterogeneous dataset to one or more of the labeler computing devices 15(1)-15(n) where one or more operators can review the online reviews designated for the particular one of the labeler computing devices 15(1)-15(n), assign one or more labels to each of the online reviews, and then transmit those assigned labels for the online reviews back to the asset analysis computing device 12 for further analysis although these labels can be obtained in other manners.

In this particular example, the labels utilized by the asset analysis computing device 12 are for pre-defined property asset problem categories comprising crime issues, noise issues, pest issues, and parking issues for text classification, although other types and/or numbers labels for these and/or other categories may be used, such as for maintenance issues, management-related concerns, and/or renovation need issues for property assets or other types of issues for other assets by way of example only. More specifically in this particular example, the labels for these four pre-defined property asset problem categories are defined as: (1) Crime and violence: Have violent or severe crimes occurred at the property asset or very close by (within a designated perimeter)?; (2) Noise issues/thin walls: Are there constant noise issues at the property asset, either due to environmental or structural reasons?; (3) Pests/vermin: Are pests, roaches and vermin a significant and constant concern for residents at the property asset?; and (4) Parking: Are there not enough parking spaces for residents at the property asset and its immediate surrounding? These pre-defined property asset problem categories are used in this particular example because of their high interest to real estate professionals and other individuals in the property aspect space, such as tenants, although again other types and combinations of categories may be used.

In this particular example, the asset analysis computing device 12 executes a two-stage pipeline to manage the labelling of the subset of data in the pre-defined property asset problem categories with the labeler computing devices 15(1)-15(n) to ensure label quality, although other manners and/or stages for managing this labelling may be used, such as a fully automated process with natural language processing or other processing by the asset analysis computing device 12 to execute this labeling of the subset of data.

In this particular example, at a first stage the asset analysis computing device 12 manages providing 5,500 online reviews to three different operators at three of the labeler computing devices 15(1)-15(n) that reviewed and provided a label or other annotation for any of the four pre-defined property asset problem categories in any of the 5,500 online reviews which are review are transmitted back to the asset analysis computing device 12. In this example, with this first stage 4,580 (83%) of the online reviews had consensus among the three operators at three of the labeler computing devices 15(1)-15(n) with respect to the four pre-defined property asset problem categories. For example, all three operators at three of the labeler computing devices 15(1)-15(n) may have agreed that there was no crime, no noise, there were pest issues, and there were no parking issues with the same online reviews in the 5,500 online reviews which was provided to the asset analysis computing device 12.

In this particular example, a second stage was executed by the asset analysis computing device 12 which provided the remaining 920 online reviews that were not unanimously labeled to six additional operators at six of the labeler computing devices 15(1)-15(n) with instructions to focus on the specific label(s) with respect to the four pre-defined property asset problem categories in which there was disagreement, although the asset analysis computing device 12 may manage other numbers of stages with other numbers of operators at one or more of the labeler computing devices 15(1)-15(n). The six additional operators at six of the labeler computing devices 15(1)-15(n) provided any labels in the four pre-defined property asset problem categories for these 920 online reviews back to the asset analysis computing device 12 for each of the remaining 920 online reviews. The asset analysis computing device 12 then stored the label or labels in the four pre-defined property asset problem categories identified for each of the remaining 920 online reviews based on a majority consensus from the received input from the nine operators of the labeler computing devices 15(1)-15(n), although other approaches for assigning any label or labels for these online reviews could be used. As illustrated in the table below, a distribution of the labels for the subset of online reviews for this particular example showed that 88.8% of the online reviews in the subset having none or no labels assigned.

| | Crime | Noise | Pests | Parking | None |
|---|---|---|---|---|---|
| Labels | 215 | 139 | 246 | 91 | 4888- |
| Fraction | 3.9% | 2.5% | 4.4% | 1.6% | 88.8% |

In step 106, the asset analysis computing device 12 trains one or more machine learning models in text classification based on the labelled subset of the heterogeneous dataset of stored online asset reviews, although the one or more machine learning models may be trained for other types of classifications and/or other analyses. In this particular example, the asset analysis computing device 12 trains a multi-label reviews classifier on a larger subset of the aggregated heterogeneous dataset, in this example about 3 million of the 5.5 million online reviews in the aggregated heterogeneous dataset, using an unlabeled subset of the heterogeneous dataset of stored online asset reviews from step 104. In this particular example, one or more machine learning models are trained by the asset analysis computing device 12 and ultimately reaches a mean Area Under the Receiver Operating Characteristic curve (AU-ROC) of 0.965 on the labels, although other types of accuracy measurements and/or other thresholds may be used to indicate a sufficient level of performance for the one or more machine learning models.

In step 108, the asset analysis computing device 12 may optionally further execute further language model fine-tuning for the one or more trained machine learning models. In this example, the asset analysis computing device 12 may conduct one or more types of analytics on the sampled larger subset, e.g. 3 million unlabeled online reviews in this particular example, to ensure this larger subset again provided a representative sampling of the aggregated heterogeneous database based on one or more applied metrics.

Accordingly, in examples of this technology the asset analysis computing device 12 may execute additional language model fine-tuning on the one or more trained machine learning models since the langue models were trained on a different corpus. The fine-tuning on unlabeled reviews is intended to further improve classification results of the one or more machine learning models. In step 110, the asset analysis computing device 12 executes the trained one or more machine learning models in text classification on the heterogeneous dataset of stored online asset reviews to calculate a category assessment score in each of the pre-defined property asset problem categories stored in the asset analysis computing device 12, although other types of scoring with other numbers and/or combinations of models can be executed can be executed. In this particular example, the asset analysis computing device 12 uses a DistilBERT machine learning language model with and without fine tuning and a RoBERTa machine learning language model with and without fine tuning for text classification on the approximately 5.5 million online reviews in the heterogeneous dataset, although other types of models could be used. Additionally, this type of analysis with the trained machine learning models could not be replicated by a manual review because of a number of factors including the size of the dataset of online reviews and the inherent subjectivity of any such purely manual review which could not consistent and accurately apply the same analytics.

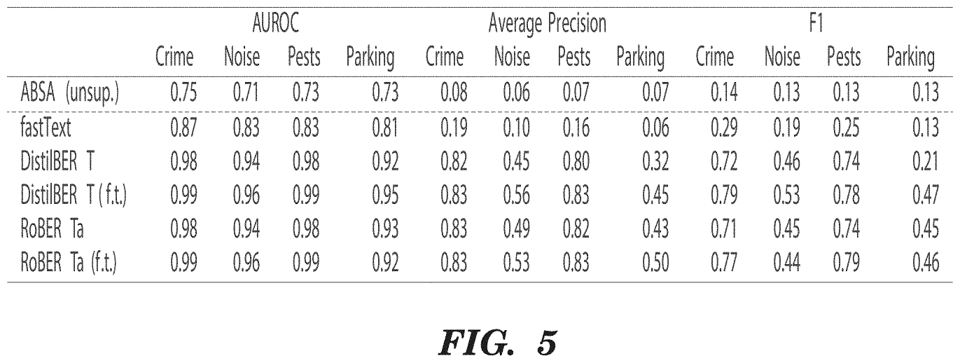

Referring to FIG. 5, a table of AUROC, average precision, and F1 calculated scores using the DistilBERT machine learning model with and without fine tuning and the RoBERTa machine learning model with and without fine tuning trained on our labeled dataset trained on the labeled dataset as well as using an ABSA classification model and a fastText model for comparison in each of the pre-defined property asset problem categories is illustrated. The numbers in this table represent the average cross-validated scores using the probabilistic, not thresholded, predictions, except for F1 in which the optimal threshold was chosen separately for each model and label. As illustrated in this example, the fine-tuned DistilBERT machine learning language model and RoBERTa machine learning language model outperformed the trained base machine learning model for both DistilBERT and RoBERTa. As baselines, comparisons to fastText, an efficient C++ implementation of a Bag-of-Words-based classification algorithm and to a BERT-based, ABSA classification model are also illustrated. The latter model is composed of a HuggingFace implementation of a BERT model, a subsequent dropout layer, and a dense classification layer, and was not post-trained on the labels. As illustrated, negative sentiment was evaluated on four pre-defined property asset problem categories corresponding to the labels “crime”, “noise”, “pests”, and “parking” and scored. In this example, the trained machine learning models executed by the assets analysis computing device 12 also provided predictions that were highly correlated with labeler uncertainty which could be output to identify inherent ambiguity in any label definitions in pre-defined property asset problem categories so additional fine tuning or other corrective actions could be implemented.

In step 112, the asset analysis computing device 12 calculates a property asset assessment score for each of the one or more property assets based on the calculated category assessment score for each of the pre-defined property asset problem categories, although other types and/or numbers of scores or other calculations could be executed. In this particular example, the property asset assessment score for each of the property assets is calculated by the asset analysis computing device 12 based on a stored algorithm which utilizes an average of the calculated category assessment score in each of the pre-defined property asset problem categories, although other manners for determining the property asset assessment score. By way of example, the asset analysis computing device 12 may also apply a weight to one or more of the calculated category assessment score for each of the pre-defined property asset problem categories based on one or more factors, such as adjusting the significance of one or more of the calculated category assessment scores up or down based on the type of property asset, the cost of the property asset, a defined type of tenant for the property asset, the geographical location of the property asset, and/or the age of the property asset, although other types of adjustments based on other factors could be used. The calculated score by the asset analysis computing device 12 can for example be a linear addition of the category scores by their weights, can be a nonlinear combination of category scores, or other types of aggregation functions that take into account the category scores. By way of a simplified example, assume a property asset has 100 reviews with an average model predicted crime score of 0.5, average model predicted noise score of 0.1, average model predicted parking score of 0.9, and average model predicted pests score of 0.2. In this example, the asset analysis computing device 12 may linearly weight each category equally with a weight of 0.25. As a result, in this example the ultimate asset score calculated by the asset analysis computing device 12 would be (0.25*0.5)+(0.25*0.1)+(0.25*0.9)+(0.25*0.2)=0.425. However, in other examples the asset analysis computing device 12 can take into account other factors, such as data on the corresponding demographics in the same geographic area by way of example, that impact the significance of each of these scores differently to obtain a customized asset score. For example, in an area where crime is not a substantial factor—which may be determined by the asset analysis computing device 12 based on obtained data of the region's demographics, the asset analysis computing device 12 can adjust the calculation to minimize the crime category's importance by taking the square of the category value. Using the above example, this non-linear formula would then equate to: (0.25*0.5*0.5)+(0.25*0.1)+(0.25*0.9)+(0.25*0.2)=0.3625, although other types and/or numbers about other factors may be utilized for other non-linear adjustments.

Accordingly, as illustrated and described by way of the examples herein, examples of this technology provide methods, non-transitory computer readable media, and computing apparatuses that effectively, accurately and consistently detect problems and rank attractiveness of real-estate property assets from online asset reviews. Additionally, examples of the claimed technology systematically minimize and/or eliminate errors with analyzing this vast heterogeneous dataset of online reviews to provide an efficient, accurate, and consistent scored output in the selected pre-defined property asset problem categories. Further, examples of the claimed technology are able to further adjust the property asset assessment score to adjust for other factors relating to the significance of the each of the determined scores in each of the pre-defined property asset problem categories.

Having thus described the basic concept of examples of this technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of examples of this technology. Additionally, the recited order of processing elements or sequences, or the use of numbers, letters, or other designations therefore, is not intended to limit the claimed processes to any order except as may be specified in the claims. Accordingly, examples of this technology are limited only by the following claims and equivalents thereto.

What is claimed is:

1. A method for automating assessment of real-estate property assets, the method comprising:
aggregating, by a computing device, a heterogeneous dataset of stored online asset reviews for one or more property assets based on one or more search criteria;
managing labelling, by the computing device, of a subset of the aggregated heterogeneous dataset in one or more pre-defined property asset problem categories with one or more labeler computing devices;
training, by the computing device, one or more machine learning models in text classification based on the labelled subset and another unlabeled subset of the heterogeneous dataset of stored online asset reviews;
executing, by the computing device, the trained one or more machine learning models in text classification on the heterogeneous dataset of stored online asset reviews to calculate a category assessment score in each of the pre-defined property asset problem categories; and
calculating, by the computing device, a property asset assessment score for each of the one or more property assets based on the calculated category assessment score in each of the pre-defined property asset problem categories.

2. The method as set forth in claim 1 further comprising:
randomly sampling, by the computing device, the aggregated heterogeneous dataset to obtain the subset of the aggregated heterogeneous dataset.

3. The method as set forth in claim 1 further comprising:
executing, by the computing device, additional tuning of the one or more machine learning models based on a larger unlabeled subset of the aggregated heterogeneous dataset.

4. The method as set forth in claim 1 wherein the managing labelling of a subset of the aggregated heterogeneous dataset further comprises:
managing, by the computing device, at least a two stage process of labelling each of the online reviews in the subset of the aggregated heterogeneous dataset in one or more pre-defined property asset problem categories by a plurality of labeler computing devices, wherein any inconsistency in the labelling between the two stages is resolved based on a majority rule.

5. The method as set forth in claim 1 wherein the one or more pre-defined property asset problem categories comprise a crime issue category, a noise issue category, a pest issue category, and a parking issue category.

6. The method as set forth in claim 1 wherein the one or more pre-defined property asset problem categories further comprise a plurality of the pre-defined property asset problem categories and wherein the calculating the property asset assessment score further comprises:
executing, by the computing device, an aggregation formula on the calculated category assessment score for each of the plurality of pre-defined property asset problem categories, wherein a weight is applied to one or more of the calculated category assessment scores for the plurality of pre-defined property asset problem categories and then the calculated category assessment score are aggregated to calculate the property asset assessment score.

7. A non-transitory machine readable medium having stored thereon instructions comprising executable code that, when executed by one or more processors, causes the processors to:
aggregate a heterogeneous dataset of stored online asset reviews for one or more property assets based on one or more search criteria;
manage labelling of a subset of the aggregated heterogeneous dataset in one or more pre-defined property asset problem categories with one or more labeler computing devices;
train one or more machine learning models in text classification based on the labelled subset and another unlabeled subset of the heterogeneous dataset of stored online asset reviews;
execute the trained one or more machine learning models in text classification on the heterogeneous dataset of stored online asset reviews to calculate a category assessment score in each of the pre-defined property asset problem categories; and
calculate a property asset assessment score for each of the one or more property assets based on the calculated category assessment score in each of the pre-defined property asset problem categories.

8. The medium as set forth in claim 7 wherein the executable code, when executed by the processors, further causes the processors to:
randomly sample the aggregated heterogeneous dataset to obtain the subset of the aggregated heterogeneous dataset.

9. The medium as set forth in claim 7 wherein the executable code, when executed by the processors, further causes the processors to:
execute additional tuning of the one or more machine learning models based on a larger unlabeled subset of the aggregated heterogeneous dataset.

10. The medium as set forth in claim 7 wherein for the manage labelling of the subset of the aggregated heterogeneous dataset, the executable code, when executed by the processors, further causes the processors to:
manage at least a two-stage process of labelling each of the online reviews in the subset of the aggregated heterogeneous dataset in one or more pre-defined property asset problem categories by a plurality of labeler computing devices, wherein any inconsistency in the labelling between the two stages is resolved based on a majority rule.

11. The medium as set forth in claim 7 wherein the one or more pre-defined property asset problem categories comprise a crime issue category, a noise issue category, a pest issue category, and a parking issue category.

12. The medium as set forth in claim 7 wherein the one or more pre-defined property asset problem categories further comprise a plurality of the pre-defined property asset problem categories; and
wherein for the calculate the property asset assessment score, the executable code, when executed by the processors, further causes the processors to:
execute an aggregation formula on the calculated category assessment score for each of the plurality of pre-defined property asset problem categories, wherein a weight is applied to one or more of the calculated category assessment scores for the plurality of pre-defined property asset problem categories and then the calculated category assessment score are aggregated to calculate the property asset assessment score.

13. A computing device comprising memory comprising programmed instructions stored thereon and one or more processors configured to execute the stored programmed instructions to:
aggregate a heterogeneous dataset of stored online asset reviews for one or more property assets based on one or more search criteria;
manage labelling of a subset of the aggregated heterogeneous dataset in one or more pre-defined property asset problem categories with one or more labeler computing devices;
train one or more machine learning models in text classification based on the labelled subset and another unlabeled subset of the heterogeneous dataset of stored online asset reviews;
execute the trained one or more machine learning models in text classification on the heterogeneous dataset of stored online asset reviews to calculate a category assessment score in each of the pre-defined property asset problem categories; and
calculate a property asset assessment score for each of the one or more property assets based on the calculated category assessment score in each of the pre-defined property asset problem categories.

14. The device as set forth in claim 13 wherein the processors are further configured to execute the stored programmed instructions to:
randomly sample the aggregated heterogeneous dataset to obtain the subset of the aggregated heterogeneous dataset.

15. The device as set forth in claim 13 wherein the processors are further configured to execute the stored programmed instructions to:
execute additional tuning of the one or more machine learning models based on a larger unlabeled subset of the aggregated heterogeneous dataset.

16. The device as set forth in claim 13 wherein for the manage labelling of the subset of the aggregated heterogeneous dataset, the processors are further configured to execute the stored programmed instructions to:
manage at least a two-stage process of labelling each of the online reviews in the subset of the aggregated heterogeneous dataset in one or more pre-defined property asset problem categories by a plurality of labeler computing devices, wherein any inconsistency in the labelling between the two stages is resolved based on a majority rule.

17. The device as set forth in claim 13 wherein the one or more pre-defined property asset problem categories comprise a crime issue category, a noise issue category, a pest issue category, and a parking issue category.

18. The device as set forth in claim 13 wherein the one or more pre-defined property asset problem categories further comprise a plurality of the pre-defined property asset problem categories; and
wherein for the calculate the property asset assessment score, the processors are further configured to execute the stored programmed instructions to:
execute an aggregation formula on the calculated category assessment score for each of the plurality of pre-defined property asset problem categories, wherein a weight is applied to one or more of the calculated category assessment scores for the plurality of pre-defined property asset problem categories and then the calculated category assessment score are aggregated to calculate the property asset assessment score.
